(19) United States
(12) Patent Application Publication
(10) Pub. No.: US 2014/0122295 A1
(43) Pub. Date: May 1, 2014

(54) Community Award and Incentive Methods and Systems

(71) Applicants: Jonathan Calmus, Los Angeles, CA (US); Karl Chodakiewitz, Beverly Hills, CA (US); David Govea, Oceanside, CA (US)

(72) Inventors: Jonathan Calmus, Los Angeles, CA (US); Karl Chodakiewitz, Beverly Hills, CA (US); David Govea, Oceanside, CA (US)

(21) Appl. No.: 14/067,840

(22) Filed: Oct. 30, 2013

Related U.S. Application Data
(60) Provisional application No. 61/720,348, filed on Oct. 30, 2012.

(51) Int. Cl. G06Q 30/06

(52) U.S. Cl. CPC G06Q 30/0609
USPC 705/26.35

(57) ABSTRACT

Embodiments are directed to an apparatus or method that includes a processor communicatively coupled to a non-transitory computer readable storage medium configured to provide a borrower with a user interface that allows the user to indicate a desire to borrow a good within a community with limited text input from a lender, automatically remind a borrower to return the borrowed goods and generate for a lender a reputation score that rates the reputation between the borrower and the lender.

### CROSS-REFERENCE TO RELATED APPLICATIONS

This application claims priority to and benefit of U.S. Provisional Application No. 61/720,348, entitled “Community Award and Incentive Methods and Systems” filed Oct. 30, 2013, which is incorporated herein by reference in its entirety.

### BACKGROUND

Embodiments of the systems and methods discussed herein relate generally to the field of community awards and incentive.

### SUMMARY OF THE DISCLOSURE

Embodiments are directed to an apparatus or method that includes a processor communicatively coupled to a non-transitory computer readable storage medium configured to provide a borrower with a user interface that allows the user to indicate a desire to borrow a good within a community with limited text input or visual selection by a mouse or touch based input device from a lender, automatically remind a borrower to return the borrowed goods and generate for a lender a reputation score that rates the reputation between the borrower and the lender.

### BRIEF DESCRIPTION OF THE DRAWINGS

FIG. 1 illustrates a system diagram of an example processing system.

FIG. 2 illustrates a system diagram of another example processing system.

FIG. 3 illustrates a flow diagram where participation based incentivization that may be implemented by the systems in FIGS. 1 and 2.

FIG. 4 illustrates the community sponsor dashboard communications.

FIG. 5 illustrates two measures of reputation evaluation that may be used by the systems in FIGS. 1 and 2.

FIG. 6 illustrates an example reputation report that that may be generated by the system.

FIG. 7 illustrates a screen display that may be generated by one more of the systems discussed herein.

FIG. 8 illustrates a screen display that may be generated by one more of the systems discussed herein.

FIG. 9 illustrates a screen display that may be generated by one more of the systems discussed herein.

FIG. 10 illustrates a screen display that may be generated by one more of the systems discussed herein.

FIG. 11 illustrates a screen display that may be generated by one more of the systems discussed herein.

FIG. 12 illustrates a screen display that may be generated by one more of the systems discussed herein.

FIG. 13 illustrates a screen display that may be generated by one more of the systems discussed herein.

FIG. 14 illustrates a screen display that may be generated by one more of the systems discussed herein.

FIG. 15 illustrates a screen display that may be generated by one more of the systems discussed herein.

FIG. 16 illustrates a screen display that may be generated by one more of the systems discussed herein.

FIG. 17 illustrates a screen display that may be generated by one more of the systems discussed herein.

FIG. 18 illustrates a screen display that may be generated by one more of the systems discussed herein.

FIG. 19 illustrates a flow chart that may be implemented by one more of the systems discussed herein.

### DETAILED DESCRIPTION

### Screen Interface

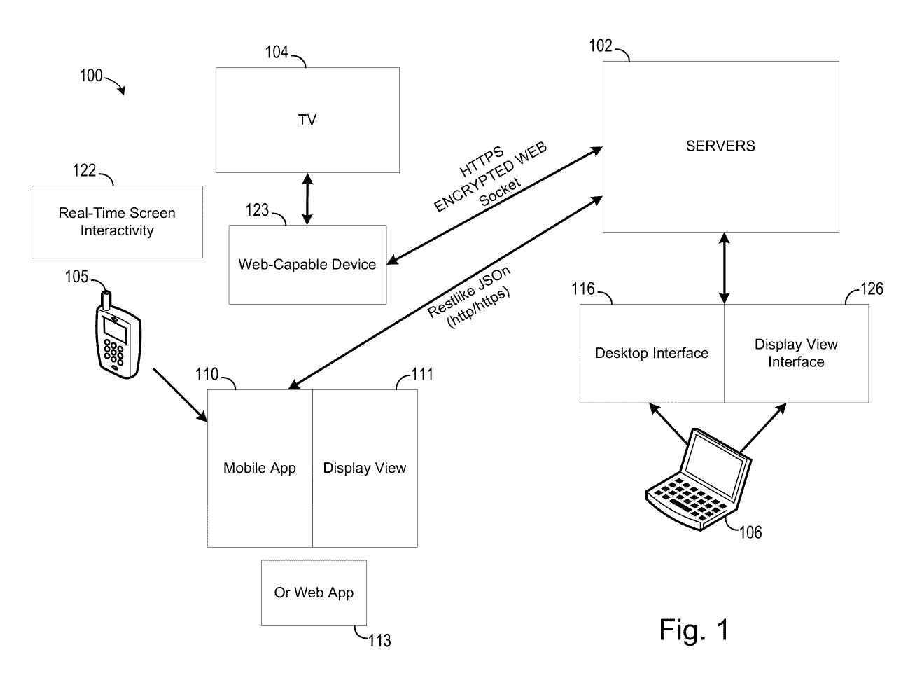

Referring to FIG. 1, FIG. 1 illustrates a system diagram of an example data processing system 100. Data processing system includes a plurality of computer systems, such as but not limited to, server 102, display screen 104, mobile device 105, and web access device 121. These computer systems devices may access and provide various interfaces, such as but not limited to, mobile app 110, display view 111, desktop interface 116, display view interface 126, and real-time screen interactivity. Portions of the system 100 may be implemented at a residential location, such as but not limited to an apartment complex, a set of houses, a dormitory or a geographic located community. For example, the display screen 104 and web access device 121 may be located at a common area of a residential location. The web access device 121 may be configured to communicate with the Internet, server 102 and mobile device 105. The web access device 121 may also be configured to generate a screen display that may be displayed by display screen 104.

The server 102 may include a processor, memory, hard drive, and network connection capabilities. The server 102 may receive requests for data from a variety of devices, such as but not limited to, web access device 121, mobile app 110 or user device 106. The server 102 may store information regarding a plurality of residential communities and provide the information to a plurality of devices based on their locations. The server 102 may update each of the devices to reflect the latest information.

In some embodiments, the web access device 121 may communicate with the mobile device 105. A user provides information to the web access device 121 by using the mobile device 105. In various embodiments, after receiving information from the mobile device 105, the web access device may update the display screen 104 to reflect the real-time screen interactivity. In various embodiments, the web access device 121 may use a secure (https encrypted web socket) to communicate (send or receive) the updated information to the server 102. In some embodiments, the updated information that is sent to the server 102 may be received from the real-time screen interactivity 122. The mobile device 150 may communicate with the web access device 121 via an Internet connection or a mobile application 110. In some embodiments, in order to access the web access device 121, the user may have to provide an access code and identify the device using the geographic location of the web access device 121. In other embodiments, the web access device 121 may include a processor, memory, GPU, network communication card and/or memory card slot. The web access device 121 may also include a port and circuitry to receive a wired Internet connection (e.g. USB, RJ45, CAT 5 cable). In other embodiments, the web access device may include a wireless antenna for communicating with a WLAN or a WWAN network.

The mobile device 105 may be used by a user that either resides in the residential community or manages the residential community. In various embodiments, the mobile device 105 may be a mobile phone, smart phone, tablet computer, laptop computer, desktop computer, GPS device or the like. The mobile device 105 may be capable of determining whether it is located within a predetermined vicinity of the web access device 121. The area of the predetermined vicinity may be based on the size of the residential community that is serviced by a web access device 121 or the display screen 104. The mobile device 105 may be capable of communicated wirelessly or by using a wire to the Internet. In some embodiments, the mobile device 105 may include a mobile application 110 (purchased and/or downloaded from an application purchase store), a display view 111 or a web application 113. In some embodiments, the mobile device 105 may communicate with the web access device 121 and receive information regarding content that is being displayed at the display screen 104. In various embodiments, the mobile device 105 may generate a display view 111 that displays the information that is displayed on the display screen 104 by the web access device 121. In other embodiments, the mobile device 105 may have a mobile application 110 that is configured to communicate with the server 102. The mobile application 110 may be configured to send and receive information to the server and identify the user of the mobile device 105 to the server. The identity of the user may include the location (address or GPS) of the user's residence in order to verify that the user has access to the display screen of the user's residence. In other embodiments, the mobile device 105 may access a web application 113 that displays similar information as the mobile application 110. As mentioned above with respect to the web access device 121, the mobile device 105 may communicate with the web access device 121 using a real-time screen interactivity 121 interface.

The display screen 104 may be a large screen television, display screen or the like. In various embodiments, the company that owns the server 102 may provide, own or lease the display screen 104. In various embodiments, the display screen 104 may be located in the public area of a residential community. For example, in a student dormitory community the display screen 104 may be the living room television that is capable of receiving a plurality of signal types (e.g. cable, satellite, Internet, web access device 121). The web access device 121 may generate a video signal that is to be displayed on the displays screen 104. The web access device 121 based on the information received from the server 102 or the mobile device 105 may update the display screen 104 frequently. Accordingly, the display screen 104 may display updated information. In some example embodiments, the display on the display screen 104 may be updated every minute, every 5 minutes, every hour, every week and/or monthly.

User device 106 may be a tablet, laptop or desktop computer that has a larger screen display area than a mobile device 105. The user device 106 may be capable of displaying a desktop interface 116 and a display view interface 126. The desktop interface 116 may include more information per screen display compared to the information displayed on the mobile device 105. The display view interface 116 may display the information that is displayed on the display screen 104 at the residential community. The user using the user device 106 may be able to change or update the information in the server 102 by using the desktop interface. The user may be able to change the information on the display screen 104 by using the display view interface 126.

Physical screen-based community client interface (e.g. display screen 104) includes, a display screen (a physical display (monitor, TV, etc.) at a location in a community), a screen that is actively managed by an entity or an authorized manager using a user device 106. The screen has enhanced capabilities like location verification (as provided by the web access device 121 that is collocated with the display screen 104), emergency announcements by management, etc. The “Screen-View” interface describes the layout and content queuing capabilities used for displaying content to a community through a screen. In one example embodiment, HTML®(e.g. HTML5®) may be used to generate the content playlist. Other suitable standards that use Flash® or other technologies may be used. Screen view is viewable to clients (web/mobile/etc.) for reference and location of content may is displayed on the screen. The screen display client provides a bridge between the physical community space and its web-based portal. It automatically generates a dynamic visual showcase of content that is generated by the community members and the content is updated based on the resident's interaction. In some embodiments, information may be presented in a bulletin board like fashion for easy absorption by those that are passing by.

The screen software provides automatic rotation of linear playlist items, and computes the importance based on a predetermined weighting criteria (i.e. morning, afternoon, evening or time of day) of each content in order to provide the most relevant information first. For example, an upcoming event will receive increasing screen time as it approaches or closer in time to the current time. Other factors considered include: points generated by the content item, time spend on the screen, availability (of the good or resource), inter-content relationships (e.g. a story about a good), the nature of the event (is this a request?), relative demand for good (compared to other goods), and thank count (number of times an individual has thanked someone). The events may be ranked based on the number of individuals that are involved in the event. The ranking of an event may be higher when lots of individuals are participating.

The screen is capable of real-time communication with the data processing system 100 using websockets or real-time TCP communication channels (e.g. zeroMQ). This allows community notifications to be viewable instantly and be synchronized across web-enabled platforms (mobile/tablet/computer/fixed screen/local cable channel). The real-time, two-way communication also enables immediate control of physical screens, allowing screen viewers to edit and interact with the community bulletin board using their mobile device 105.

Other aspects of the physical/digital bridge includes the ability for users to access a current snapshot of their physical screen's layout directly from their community's web portal. This reverse-direction access to the screen encourages users to employ the community screen as a source for regular updates. Users are easily able to reference and explore the screen's current state from any device when presented with interesting content.

In other embodiments, aspects of the screen includes various features. Feature may include, geographically limited to a location, hourly access code that is changing, web based interface to access the screen, automatic playlist of community content, persistent websocket connection, polling for activity every 30 seconds or 1 minutes, and modifying screen content through your web enabled device. Other features include providing content to the screen via a user device, displays images, slide shows, videos and other content, web interface can adjust the screen or feed widget, and implement content on the screen. Additional or alternative features may include, hardware controls of the screen, 3d motion sensitive camera and wakeup and status update of the screen and control power, volume screen properties via a hardware input device such as a remote or a keyboard. Properties of the contents may be considered to determine how and in which order the content is displayed on the screen.

### System Overview

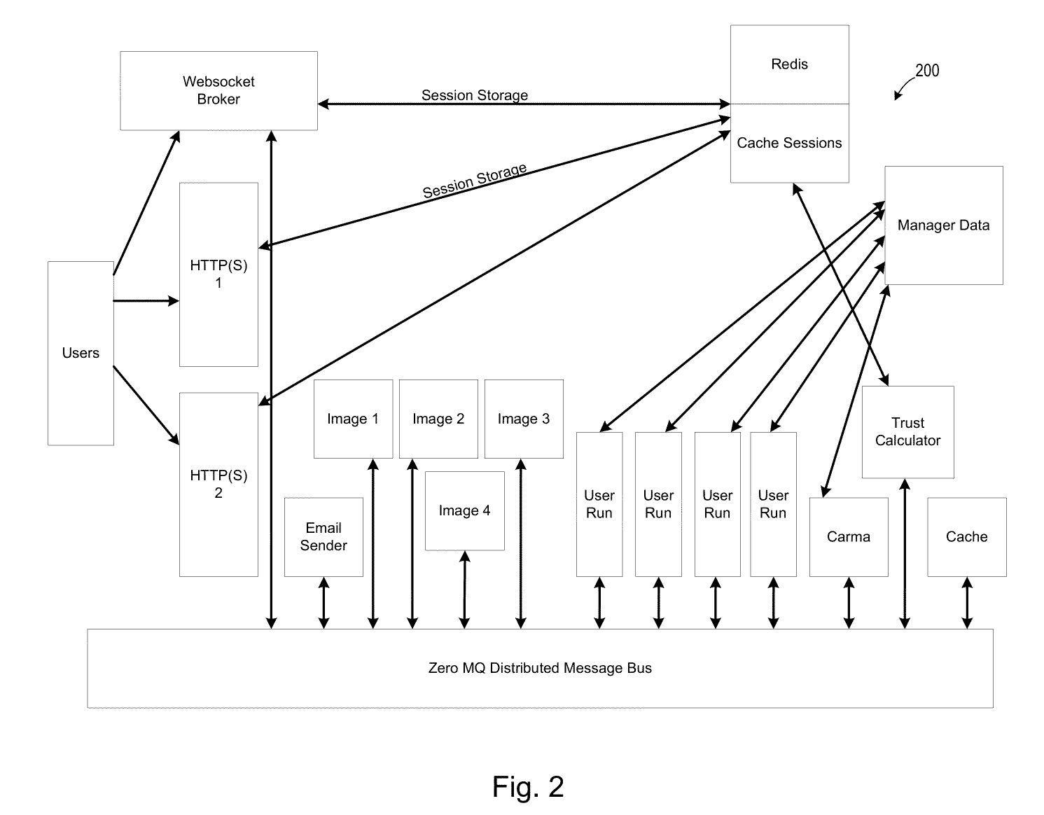

Referring to FIG. 2, FIG. 2 illustrates a system diagram of data processing system 200. Various distributed modules included in the processing system of FIG. 2. The distributed modules may be connected using a zero MQ messaging system. The system may use redis synchronized sessions across multiple HTTP nodes, websocket modules, JSON-REST module (for mobile devices). A crash only design may be used for failure of a single module has little or no impact on the entire system. New instances are easily spawned or old instances ones restarted. In one embodiment, the modules in FIG. 2 may be stateless. In other embodiments, the modules are stateful. Stateful and stateless describe whether a computer or computer program is designed to note and remember one or more preceding events in a given sequence of interactions with a user, another computer or program, a device, or other outside element. In one embodiment, stateful may mean that the computer or program keeps track of the state of interaction, usually by setting values in a storage field designated for that purpose. In one embodiment, stateless means there is no record of previous interactions and each interaction request has to be handled based on information that comes with the request.

### Incentivization and Reward System

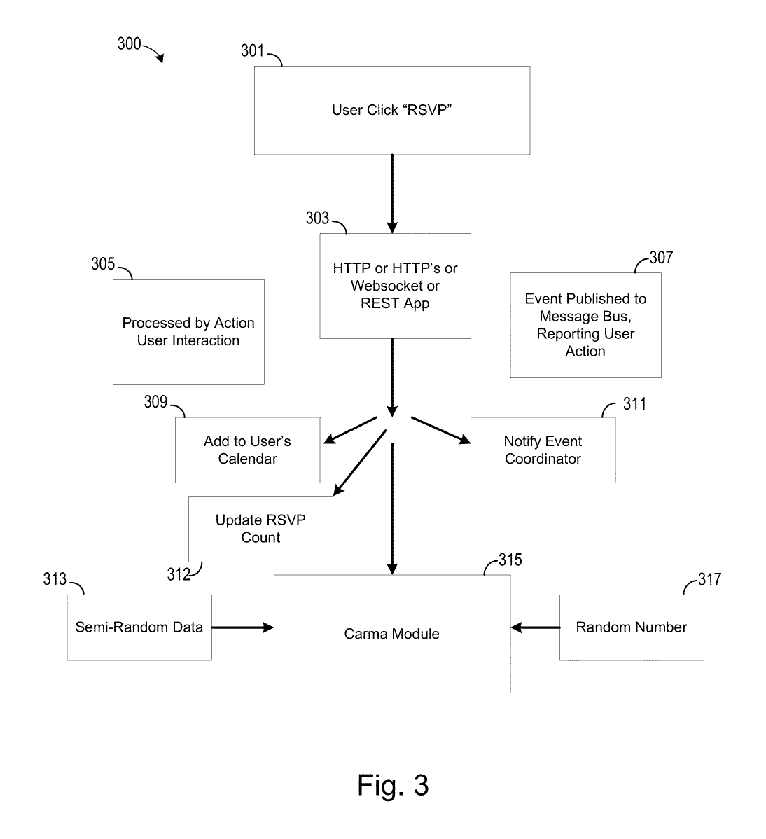

FIG. 3 illustrates a flow diagram where participation based incentivization that may be implemented by the systems in FIGS. 1 and 2. “Carma” may be a point based incetivization metric that describes a user's or community's levels of activity, neighborliness, and social responsibility. Activities on the system are valued in order to encourage users to be supportive to their physical neighbors and communities. A user's incentivization score is a valuable quantization of non-monetary forms of community support. Rewards gifted to individuals or groups are allocated based on relative incentivization scores. The score encompasses all actions performed on the system, but is primarily based on of the following factors, sharing/borrowing physical goods, organizing and attending community events, adding content to community, interacting with community supporters (sponsors), responsible community interaction (greeting new members, updating RSVP's, etc), helping to govern/improve community (reporting inappropriate posts, improving library data, etc),

In addition, the collective points of a community may be used to allocate large group rewards, and provide a comparative ranking between one or more communities. Activity is distributed through the system by distributed message queue, Carma or point processing module may assign a ranking to the activity using a random number generator, a probability setup may be used to determine the incentivization points (carma points).

Features include incentive and an activity measure, higher the points the higher the user's likelihood of receiving products or incentives, sometimes the points pay off, however, there is no guarantee. The system may provide, progress report, and provide a custom measure of activity. The incentivization points may be cashed in for payment, and it is an increasing number. Various analytics are provided to determine the correlation with product purchases and the incentivization points. No one else can see anyone else's incentiviation score (Carma points). Other users may not be able to access other users

The method includes the user generating activity through site interaction (e.g. click RSVP). Next, the activity information distribution is distributed throughout the system. The incentivization points or score is determined for the activity.

Referring to FIG. 3, FIG. 3 show a process 300 that may be implemented by the system in FIGS. 1 and 2. At step 301, the user may decide to RSVP for an event at the residential community using a user device 106 or a mobile device 105. Next at step 303, an http or https or websocket or mobile app message is generated and the message regarding the RSVP may be permeated through the entire system. At step 305, the application user interface processes the RSVP request. Next at step 307, the event is published to the message bus in FIG. 2 and the user's actions are reported to the server 102 and the display screen 104. At step 309, the user's calendar is updated. At step 312, the RSVP count for the event is updated. The event coordinator is informed regarding the RSVP of the user at step 311. The carma module or circuit (point calculation and assignment module) 315 is also informed regarding the user's RSVP in step 301. The carma module 315 is configured to receive or generate semi-random data 313 and random numbers 317 to determine the number of carma points to assign to the user's actions. The carma module 315 takes into account a plurality of factors to determine the points to be given to the user, the event coordinator and community. For example, the carma module 315 may use the number of participants that are already attending the event to determine the points. If the user that selected the RSVP is one of the first few persons to RSVP the user receives more carma points compared to if the user is one of the last users to RSVP when many other users have already decided to attend the event. In other embodiments, if the number of users that are attending the event is large (greater than 10, 20, 30, 40, 50 or 100) compared to other smaller events (<10 users), then the event coordinator may be assigned a larger number of point compared to the user that decided to attend a large event.

### Community Supporter Web Portal

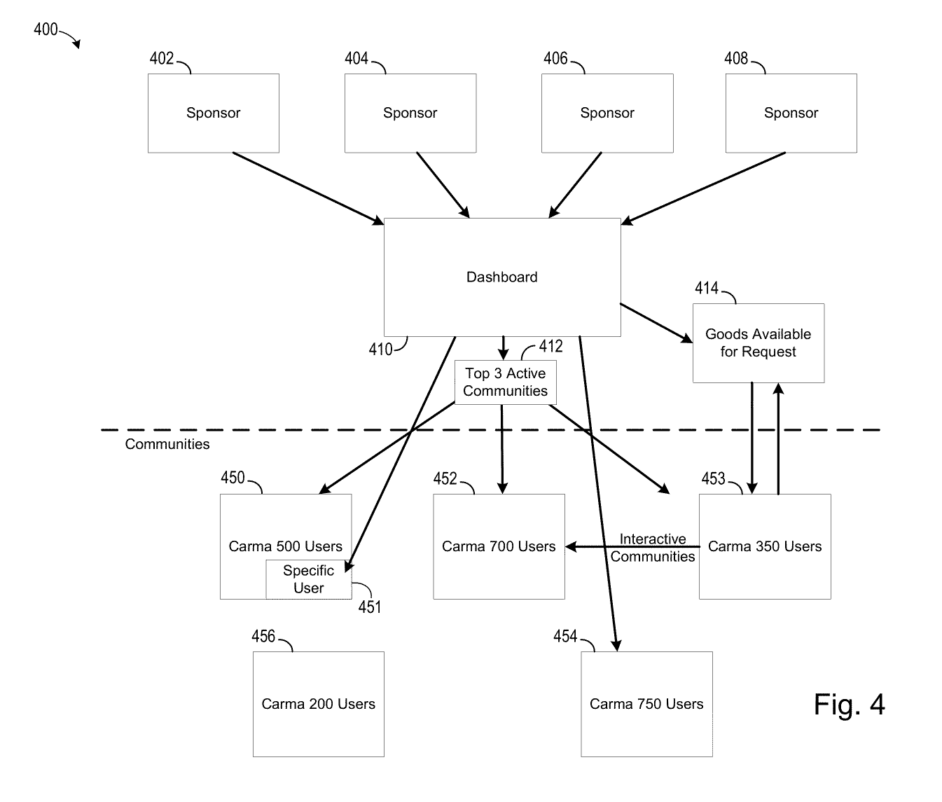

FIG. 4 illustrates the community sponsor dashboard communications process 400. The dashboard is a self-service dashboard that allows sponsors or brands to access one or more communities. The sponsors may generate custom experiential campaigns based on analytics generated by the systems in FIGS. 1-2. In addition to localized user communities, the system provides value to commercial sponsors by allowing them to act as community supporters of incentivization points. Through the community supporter dashboard, a brand owner may create and manage experiential marketing campaigns, or they may choose to support incentiviation points on a more general level. The system can automate the allocation of promotional resources, acting as a matchmaker between supporters and community needs. Incentivization points divided by the number of users may equal the normalized value of the incentive activity per user for a community or a group of communities.

Supporters may consider varied analytic user data in order to tailor their campaigns, including incentivization counts, inventory of good being shared/requested, event histories, and user media generation statistics. Campaigns can also be targeted based on, location, date, weather/environmental factors, and community's incentivization point level.

Brands are able to distribute promotional materials, support community events, gain organic brand ambassadors, and generate reusable promotional media, all while inspiring loyalty and pride in the brand. The system automatically facilitates circulation of reusable goods within a community, allowing a brand's supportive gesture to retain long-term appreciation, and be brought to the community's attention each time the gifted good is used. A single limited sampling of a product is visible to an entire community, creating demand and interest.

The dashboard includes a self service capabilities for brand owners. Generate custom experiential marketing campaigns based on custom participation based incentive measure analytics. Incentivization points (Carma) divided users is a simple analytic equal normalized value of carma activity per user. Gauge community interest based on activity. What items or goods by a community? What items or goods does the community members intend to own?

The dashboard allows a brand owner to search for a community based on incentives, events, types of events, major interests within the community, community personality. The composition of the community's incentives.

Referring to FIG. 4, FIG. 4 shows an arrangement of entities and computer systems where the residential or commercial communicates are all connected via a network (e.g. Internet) to a dashboard 410. The dashboard 410 may offer a visual dashboard to a plurality of advertisers/sponsors 402, 404, 406 and 408. The dashboard 410 allows the sponsors to access a subset of a community, a plurality of communities based on sponsors' specified parameters. The dashboard may offer the sponsors sliders that allow the sponsors to select communities to target based on carma (activity) points, age range, gender, location, vicinity to sponsor's nearest location based on sponsor profile, types of goods requested, types of good available, type of good borrowed. Each one of the above criteria may have a slider and the sponsors may be able to select or input a textual value for each criterion. Accordingly, communities and users within the communities may be filtered in or out for an advertising campaign based on the sponsor selection of the criterion. Other criteria may also be used as discussed in greater detail below.

For example, if the sponsors 402, 404, 406 and 408 want to target an advertisement campaign to the top 3 active communities 412, then they would enter that information into the dashboard 410 and the dashboard 410 may display community 450 (having 500 users), community 452 (having 700 users) and community 453 (having 350 users). In other embodiments, the sponsor 404 may want to sponsor an event with the largest number of users such as community 454 with 750 users. The sponsor 404 may enter appropriate information into the dashboard and the sponsor can address the community as a whole. The input from sponsor 404 may be received and shown to each of the community users upon their next login. The sponsor 404 is never provided any personally identifying information (name or other information regarding an individual user) of any one of the users. Each user in any community may opt out of receiving sponsor related information. Since community 456 did not meet any of the criteria selected by the sponsors 402, 404, 406 and 408, none of the sponsors may sponsor an activity at community 456. Other sponsors may be provided with an option to see communities where there has not been any sponsored event as selection criteria.

Another criterion for filtering communities and users may be goods that are available for request 414. For example, when there is a plurality of particular type of good available for borrowing, targeting those users with the same good may not yield positive results for the sponsor. Instead, the dashboard may perform a search and suggest a complementary good that works with the goods that are available. Alternatively, the dashboard system may determine that a new version of the good is now available and inform the appropriate sponsor that you may want to advertise the upgraded version of the good to the users that own a good. The goods that are available for request provides the sponsors insight into what type of activities the users of a community like. For example, if lots of users are allowing user to borrow their tents, then maybe those users may be interested in camping gear. Accordingly, goods available for request 414 may allow the sponsors to determine activities that the users of a community are interested in and promote those activities or discounts for those activities. The sponsors would not have access to which user owns which good, but the sponsors may receive data such as 31 tents are available for request.

Alternatively, a community may want to inform the dashboard or the sponsors that the community needs a particular item (e.g. volleyball net) and a sponsor may be able to provide the net in exchange for some experiential marketing from the community. For example, the sponsor may provide the net for free if there is a volleyball tournament organized at the community where the sponsor may provide its branded products for sale and use the pictures of the tournament. Other experiential marking activities may be proposed based on a mutually beneficial model.

### Reputation Evaluation Methods

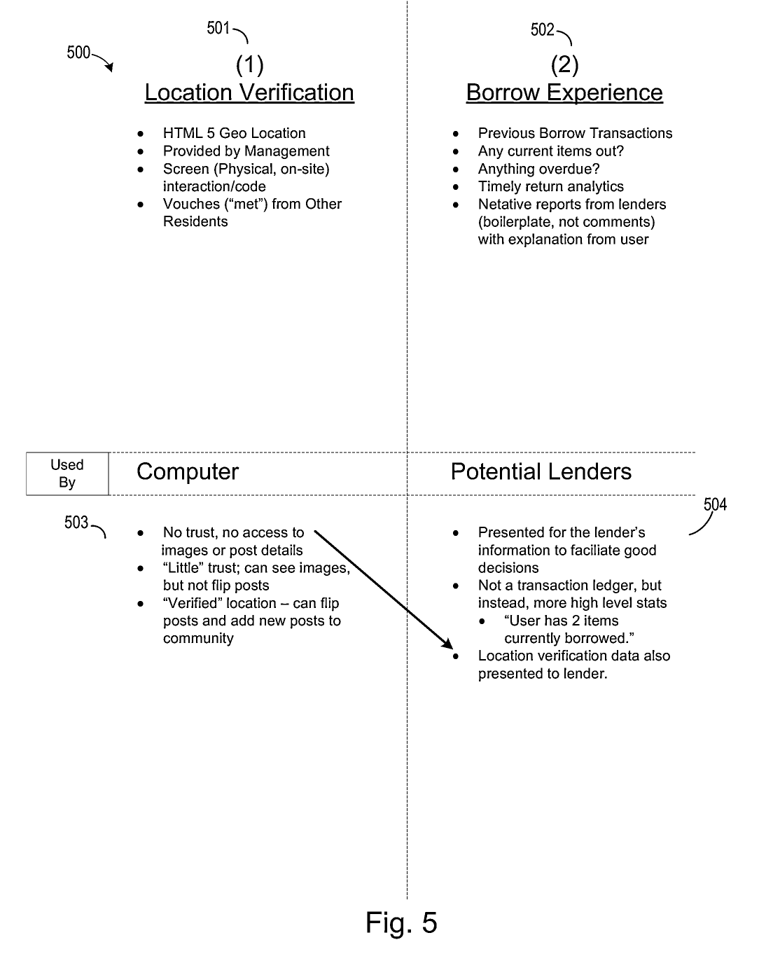

FIG. 5 illustrates two measures of reputation evaluation that may be used by the systems in FIGS. 1, 2, 3 and 4. In some embodiments, user reputation is based on two different metrics as shown in FIG. 5 e.g. location verification 501 and borrow experience 503. FIG. 5 also shows which entity would use which metric. In some embodiments, a computer 504 may use the location verification metric 501 and the potential lender 505 may use the borrow experience metric 502. The reputation evaluation is a measurement of a member's reputation which is designed to minimize privacy and sharing vulnerabilities while enabling streamlined borrowing and lending through transparent evaluations of member trust.

Trust is measured based on one or more of the following components, geographical location, direct user-to-user interactions, “Second generation” interaction links, on-site administrative input, incentivization score, locale-specific information (e.g. verification code on a physical TV screen), and diversity of trust components. Each of the components may have a weighting score and the trust may be determined based on the weighting score. In some embodiments, geographic location may be given a higher weighing. In another embodiment, geographic location may be given a lower weighting. Additionally or alternatively, some components may receive a higher weighting than other components.

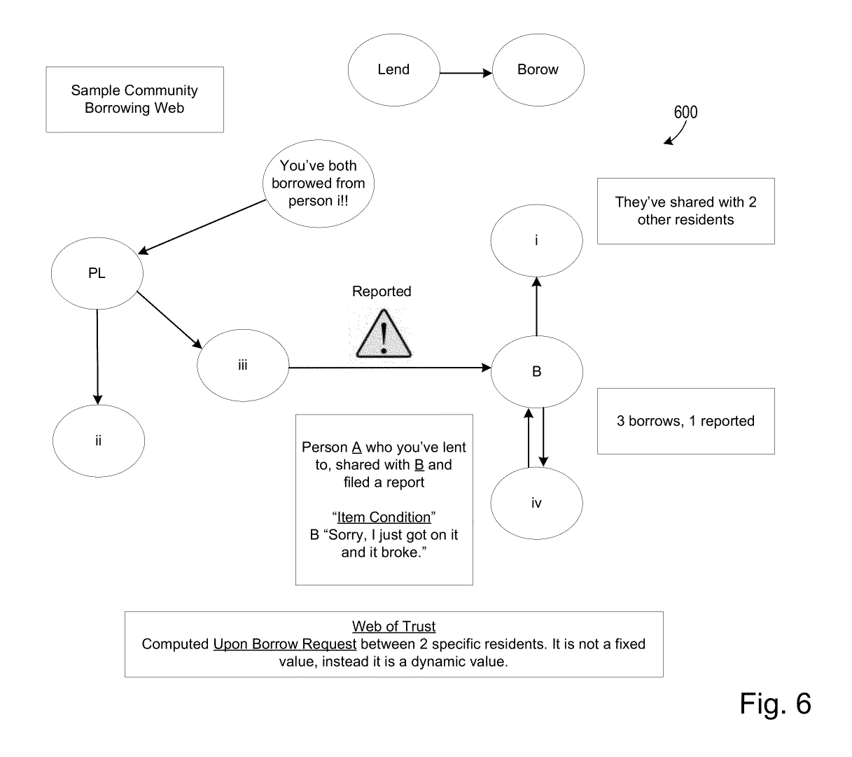

FIG. 6 illustrates an example reputation report that that may be generated by the system. A reputation score is not a static number for each user. When a potential lender is presented with a borrow request a new computation is performed. Let (PL) represent the potential lender who is deciding whether or not to share their possession. Let (B) represent the potential borrower. All the other “O” circles represent other verified residents. All O to O links represent past borrow experiences, the arrow shows the “direction” of the share. The report will recite person iii, who you've lent to, shared with B and filed a report that recites, Item Condition, sorry I just sat on it and it broke.

The reputation score varies from incentivization score in various ways. Reputation is a dynamic computation between two members. For example: if person A and person B have borrowed from each other, then, person C borrows successfully from Person B. Now, the computed reputation score between person A and person C is increased due to the “second generation” interaction.

When a member's possession is requested for borrowing, the potential lender is presented with a reputation report for the requesting member, and is encouraged to use the data presented to make an informed decision about the potential interaction. Negative lender experiences can result in a decrease in reputation for the borrower, but the types of complaints are predefined community rule set such as but not limited to, on-time return, item condition, etc.

Another role of trust or reputation measurement is to protect the privacy of community members by ensuring that only actual residents have access to the content of the community. Upon registration, a user has zero trust or reputation building elements. At this point, they are prevented from viewing almost all community content. Images are replaced with placeholders, and no borrowing is possible. With the addition of a user's first element of trust, content becomes partially available. This initial trust can be established quickly and easily via multiple routes: HTML5 geolocation, email invite from management, screen-based presence verification code, or a simple “hello” interaction with an existing member. Borrowing is still not available, but the basic details and images of community content can be viewed.

In order to unlock the full content views, a certain verification threshold must be reached by a new member. A threshold of three verified members' “hellos” has been suggested, but the exact about of trust will be determined upon further testing. This person has had a multiple transactions. If someone provides a report, the borrower could correct the situation.

If a lender reports you for the conditions, you can resolve it with the person or you can accept it and provide your own explanation. Various features are provided by the systems and method described above such as, the ability to borrow and share physical goods within your community with limited text input, providing automatic reminder, easily and safely borrow and share and physical and non-physical items. Web of trust or reputation score allows a user to determine the relative reputation of another user. The system may provide incentives to lend, provide reminders to return items automatically. Brand incentiviation ties brands to active users. Automated match making between brands and communities may be used based on the web of trust concept. A unified community access to physical and digital experiences being tied by a platform, onsite access may be provided.

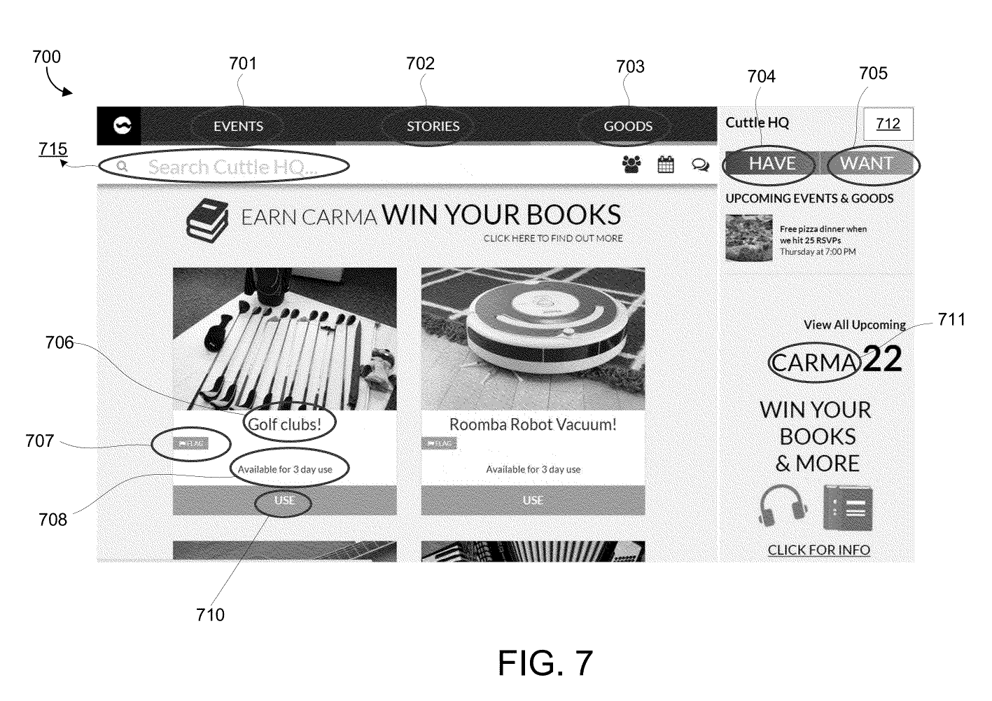

FIG. 7 illustrates a screen display 700 that may be generated by one more of the systems discussed herein. Display 700 shows an example screen when a user provides their authentication credentials to a website configured to access the server 102. The display 700 includes a plurality of links and options. For example, links for events 701, stories 702, goods 703, have 704, want 705, name of available good 706, flag 707, time of availability 708, use 710, points 711, a user provided image 712 and search 715. Each user that logs in to the website that accesses the sever 102 may identify the property which the user resides at and the information in the links described above is associated with the location of the user. After selecting events 701 link, the user may be shown a listing of the events that include images provided by the event organizer. After selecting the stores 702 link, the user may be shown a listing of the stories that have been provided by the user and other users in the community. After selecting the goods link 703 the user may be shown a plurality of goods that the user may borrow or use as shown in display 700. For example, good 706 is a set of golf clubs that is available for 3 days as indicated by the availability indicator. A user may choose to use the good 706 by selecting the use link. The user may be asked for further authenticating credentials such as but not limited to a pin. A user may select the flag to report a product to the server for removal due to, for example, its offensive nature. Additionally, a user may send a thank you note to the provider of the product and the user may receive points for thanking another user.

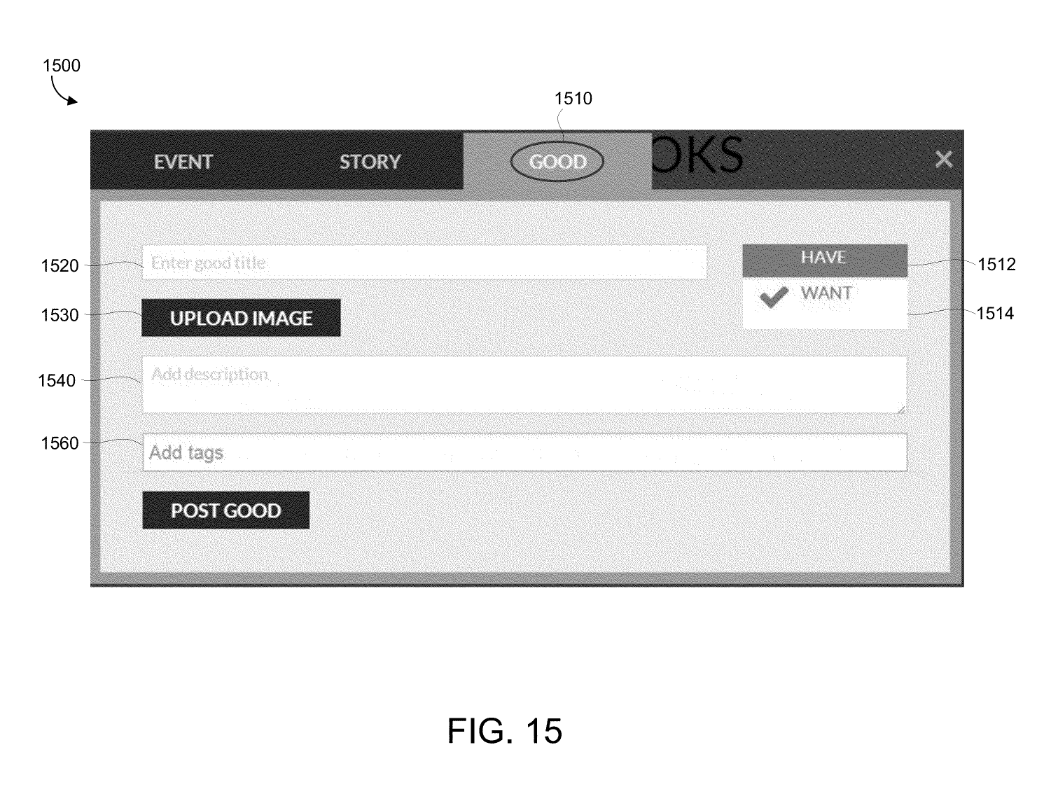

Search text box 715 allows a user to search goods, event, calendar, neighbors, planner or comments based on a search string. In other embodiments, the user may allow others to borrow (or loan) a good and select the have 704 link to display screens shown in FIGS. 15, 16, and 17. In other embodiments, the user may want to borrow goods that are not listed in the good page 703, the user may select the want link 705 and a screen that is similar to the screens shown in FIGS. 15, 16 and 17 may be displayed on the screen. In various embodiments, a user provided image 712 may be shown when the user is logged into the system.

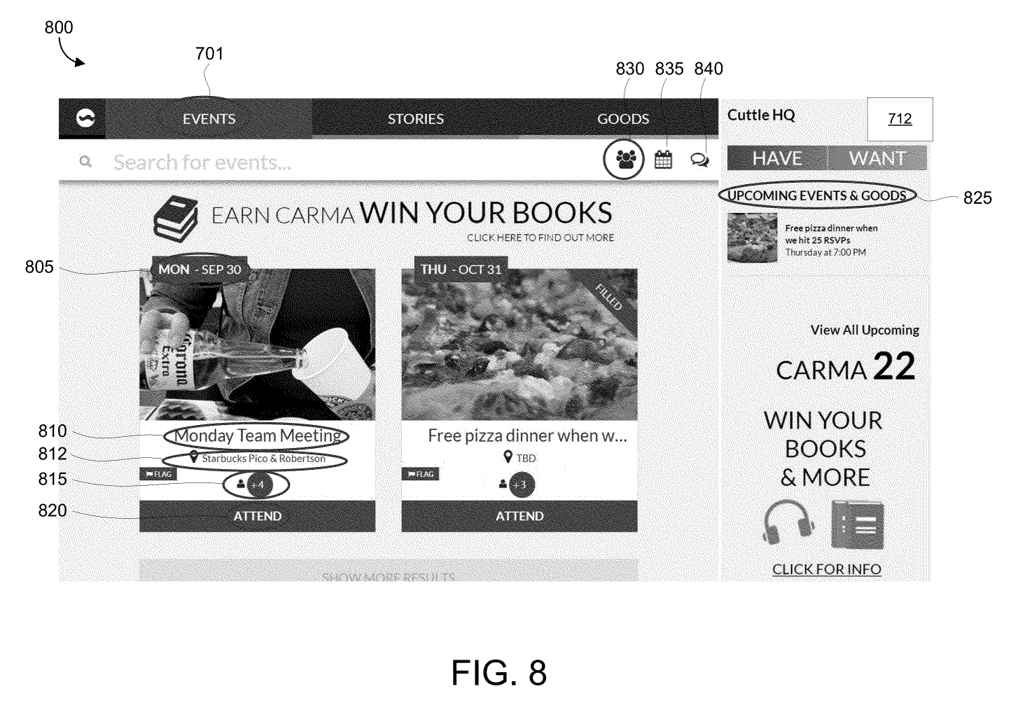

FIG. 8 illustrates a screen display 800 that may be generated by one more of the systems discussed herein. Display 800 may be generated when the user selects the events link 701 from FIG. 7 or 8. The plurality of events may be listed in a manner as shown in display 800. The date of the event 805 may be listed on the image of the event. The title 810 event of the event may be listed under the image for the event. The description and a link to the mapped location 812 may be provided under the title. A visual indicator the number of people attending the event 815 may be shown under the map. In other embodiments, when the user scrolls over the number +4 the user may be shown the images of the other users that have signed up to attend. If the user wishes to attend this event the user may select the attend link 820.

Additionally shown in FIG. 8 is the neighbors link 830, calendar link 835 and comments link 840. The neighbors link 830 shows a listing of the neighbors of the user based on the geographical proximity of other users that have decided to share their profile publically. The calendar 835, show the upcoming events or goods due dates in a listed format.

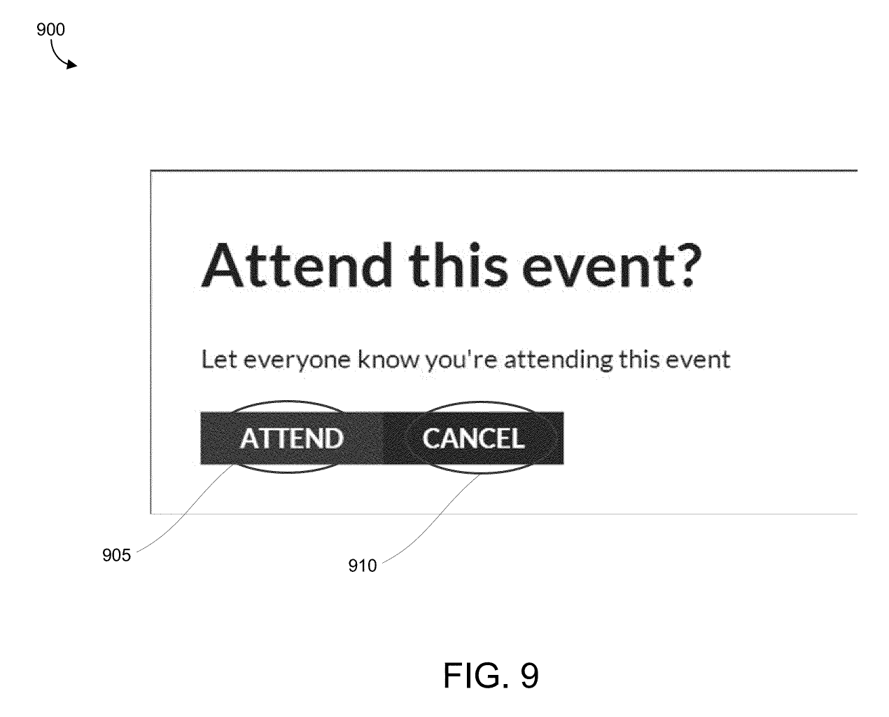

FIG. 9 illustrates a screen display 900 that may be generated by one more of the systems discussed herein. Screen display 900 may be displayed when the user has selected the attend link from screen display 800. Screen display 900 is a confirmation screen that may be generated in some embodiments based on the user profile setting. In other embodiments, the confirmation screen 900 may not be generated. When the user selects attend button 905, the server 102 is informed regarding the user's selection and the calendar of the user and the other entities are updated as described in FIG. 3 above. If the user selects the cancel button 910, then the user is taken back to the events screen display 800.

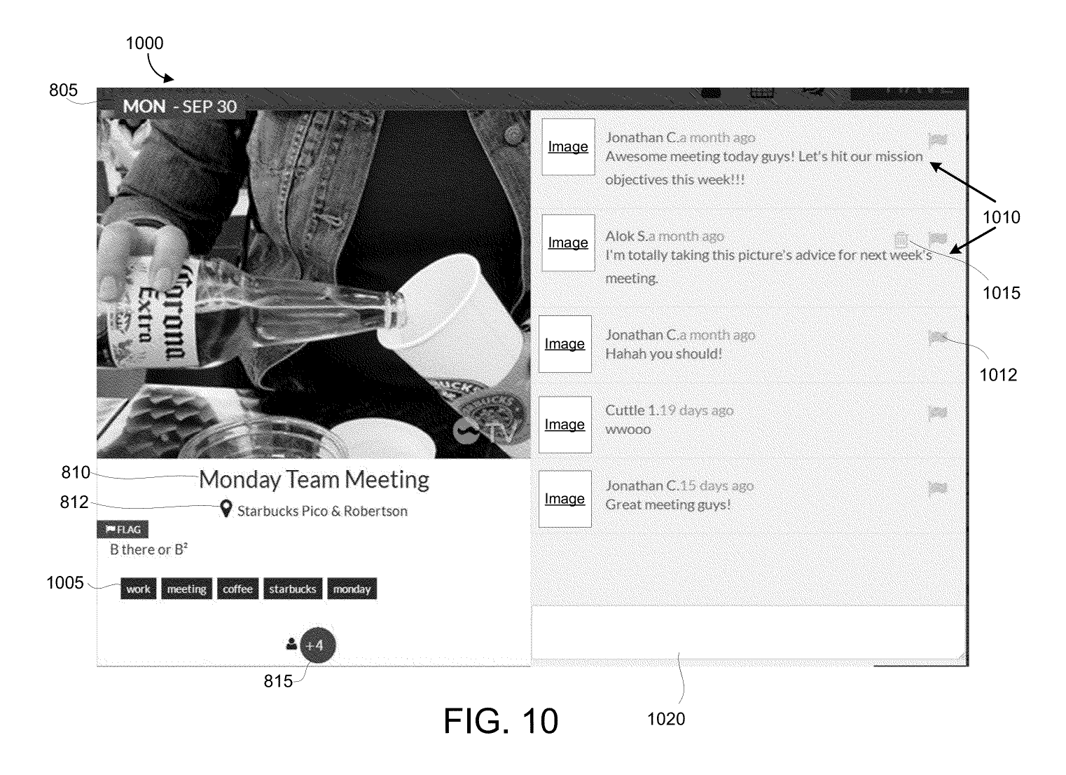

FIG. 10 illustrates a screen display 1000 that may be generated by one more of the systems discussed herein. The screen display 1000 shows a screen that may be displayed when the user wants to know more information regarding the event in FIG. 8 by selecting the image of the event. Screen display 1000 continues to show the date of the event 805, title of the event 810, location 812 and the number of attendees 815. Also shown in screen 1000 are the tags 1005 that are related to this event, such as, work, meeting, coffee, Starbucks and Monday. In some embodiments, the server 102 automatically generates some of the tags by scanning the text of the event or the location of the event. In other embodiments, the user may tag the event. The tags are especially useful when the search bar 615 is used. Also shown in display 1000 are comments 1010 that the users have provided regarding the event. The users are free to enter any comments in text box 1020 and they are uploaded and shown in real-time. Other users have the option of flagging one or more comments using the flag link 1012. Administrative users have the option of removing comments that may be incorrect or offensive to other users by using a trash button 1015. In some embodiments, when the trash button 1015 is selected, the user that posted the removed comment is informed on their mobile application or their home page that their comment was removed. An appeal processes may be implemented to allow the user that posted the comment to redisplay the originally posted comments. In some embodiments, the system 100 or 102 do not delete the comments from the server 102, they simply fail to display the comments.

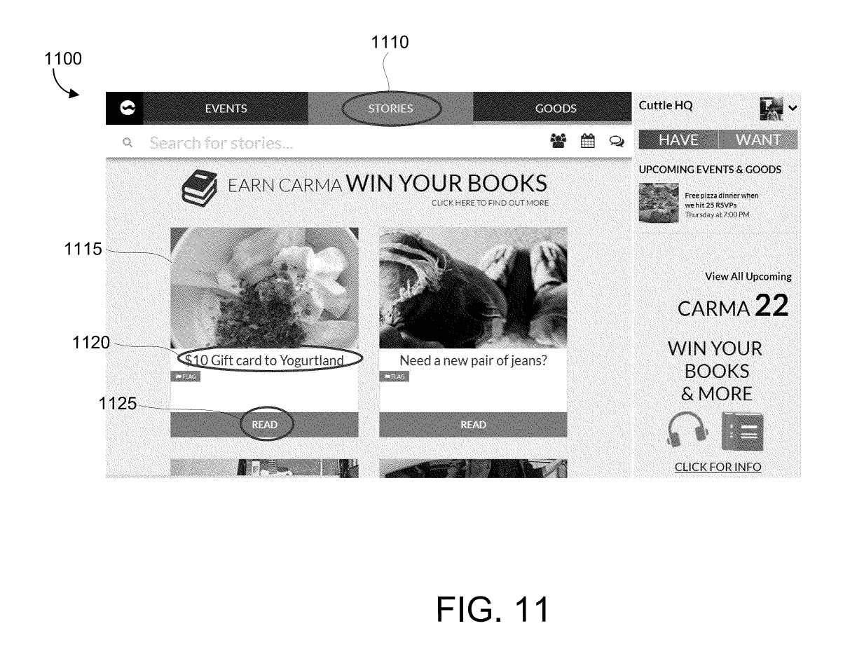

FIG. 11 illustrates a stories display 1100 that may be generated by one more of the systems discussed herein. Stories display 1100 may be shown when the user selects the stories link 1110. The stories display 1100 shows a listing of a plurality of stories. In one embodiment, the stories page may be include coupons such as a “$10 gift card to Yogurtland”. In other embodiments, stories may include past events and their comments. Also shown on the stories display 1100 is an image 1115 for each story, title of the story 1120 and a link to read the story 1125. Upon selecting the read link 1125, the user may be shown comments, more information regarding the story and a thank you note for the story provider link to earn incentivization points within the system 100.

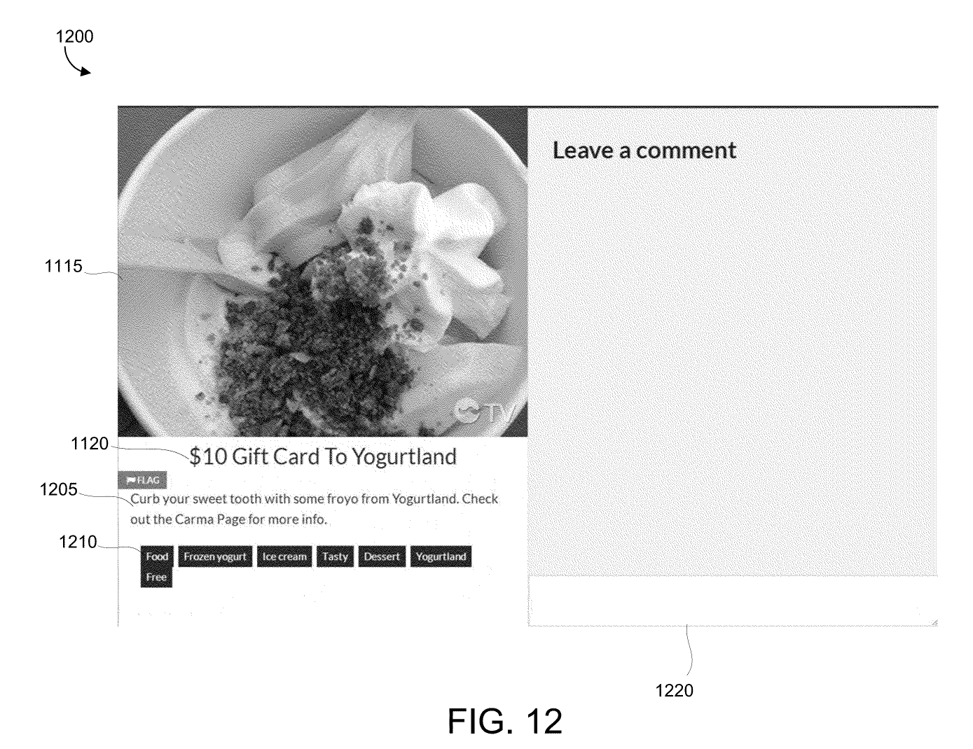

FIG. 12 illustrates a screen display 1200 that may be generated by one more of the systems discussed herein. The screen display 1200 may be displayed when the user selects the read button in display 1100. Screen display 1200 includes an image 1115 of the product, title of the story 1120, description 1205 that is provided by the storywriter and a plurality of tags 1210. As mentioned above with respect to events, the some tags are automatically generated while other tags are user selected. Also shown is a text input box 1220 that allows uses to leave comments regarding the story.

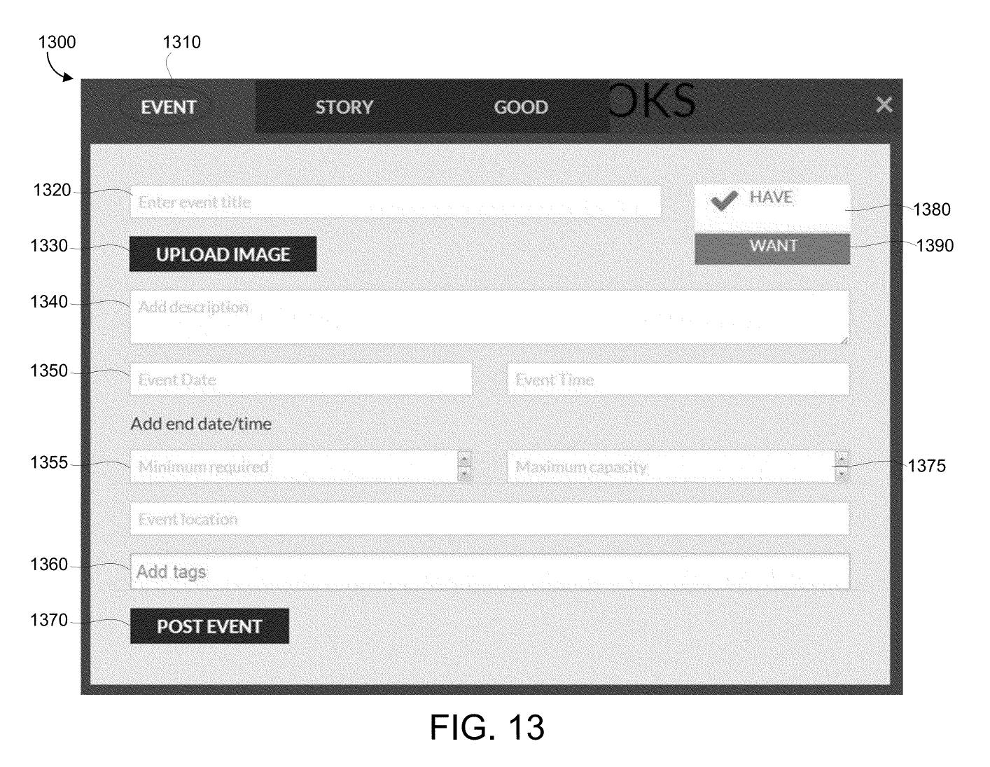

FIG. 13 illustrates a screen display 1300 that may be generated by one more of the systems discussed herein. At screen display 1300 includes a plurality of fields and user selections for a user that has an event they want to post to their community. The user may select event 1310 field and have 1380 or want 1390 link may be selected based on the user's preference. The user may enter other information regarding the event. For example, the user may enter the event title 1320, upload image button 1330, add description in text box 1340, select an event date 1350 or event time. The user may add a minimum number of users 1355 or a maximum number of attendees 1375. In various embodiments, the user may add tags 1360 and after all of the above mentioned information decide to post the event to the website.

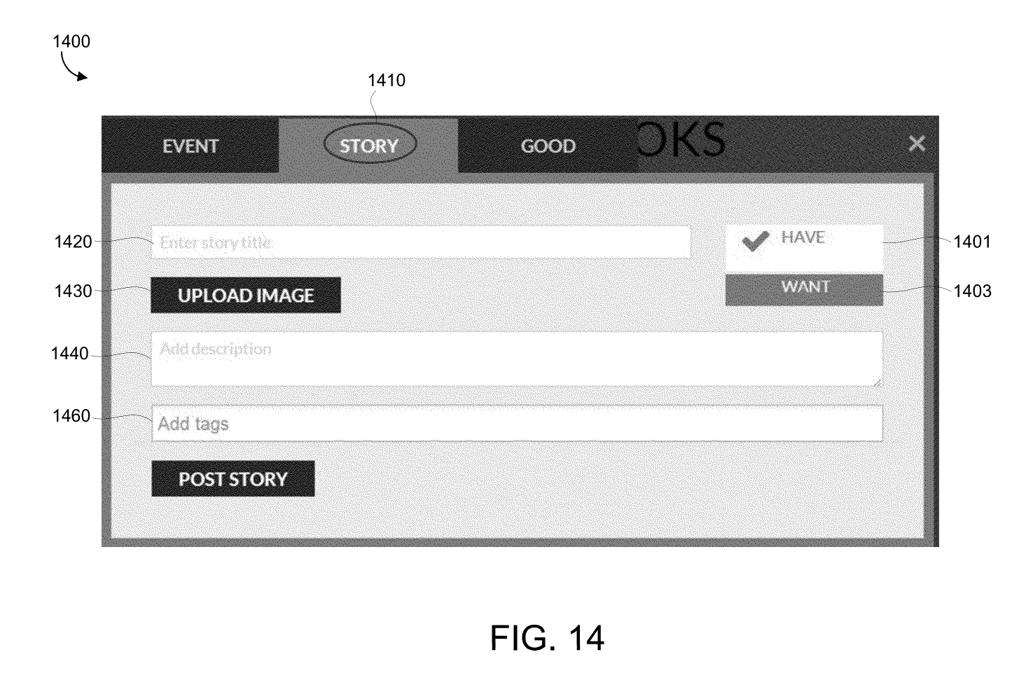

FIG. 14 illustrates a screen display 1400 that may be generated by one more of the systems discussed herein. Screen display 1400 may be generated when the user selects the want or have button in screen display 700. In this example embodiment, the user selected the story button 1410. The user may be asked to enter the title of the story in text box 1420, the user may upload an image 1430, add a description in description 1440, add one or more tags 1450 and select the post good button 1460. Each of the systems described herein may be alerted regarding the users stories and the community display screen 104 may also be updated to reflect the user's input. In other embodiments, the have button 1401 and want button 1403 are toggles and the user may enter information regarding their haves or wants based on the user preference.

FIG. 15 illustrates a screen display 1500 that may be generated by one more of the systems discussed herein. Screen display 1500 may be generated when the user selects the want or have button in screen display 700. In this example embodiment, the user selected the goods button 1510. The user may be asked to enter the title of the goods in text box 1520, the user may upload an image 1530, add a description in description 1540, add a tag 1550 and select the post good button. Each of the systems described herein may be alerted regarding the users posts and the community display screen 104 may also be updated to reflect the user's input. In other embodiments, the have button 1512 and want button 1514 are toggles and the user may enter information regarding their haves or wants based on the user preference.

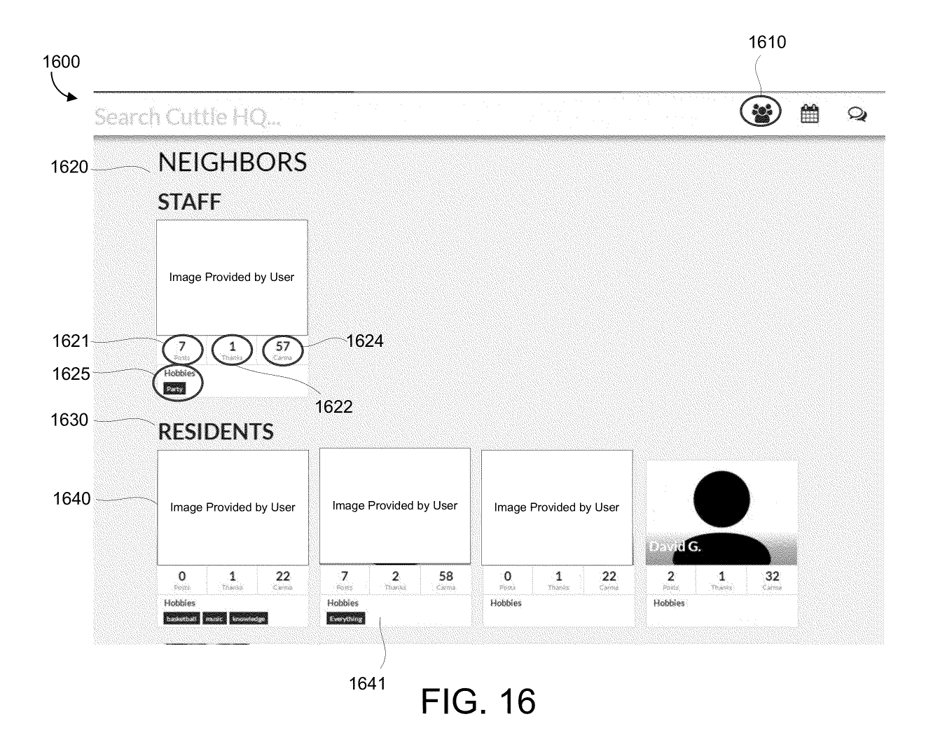

FIG. 16 illustrates a screen display 1600 that may be generated by one more of the systems discussed herein. Screen display 1600 is generated when the user selects the neighbors link 1610. In some embodiments, a staff member 1620 for the community may be displayed first. For each user the display 1600 may show the members total number of posts 1621, number of thanks 1622, and points 1624. Also listed for each user are their hobbies. Next the residents that are this user's neighbors are displayed with their posts, thanks and carma.

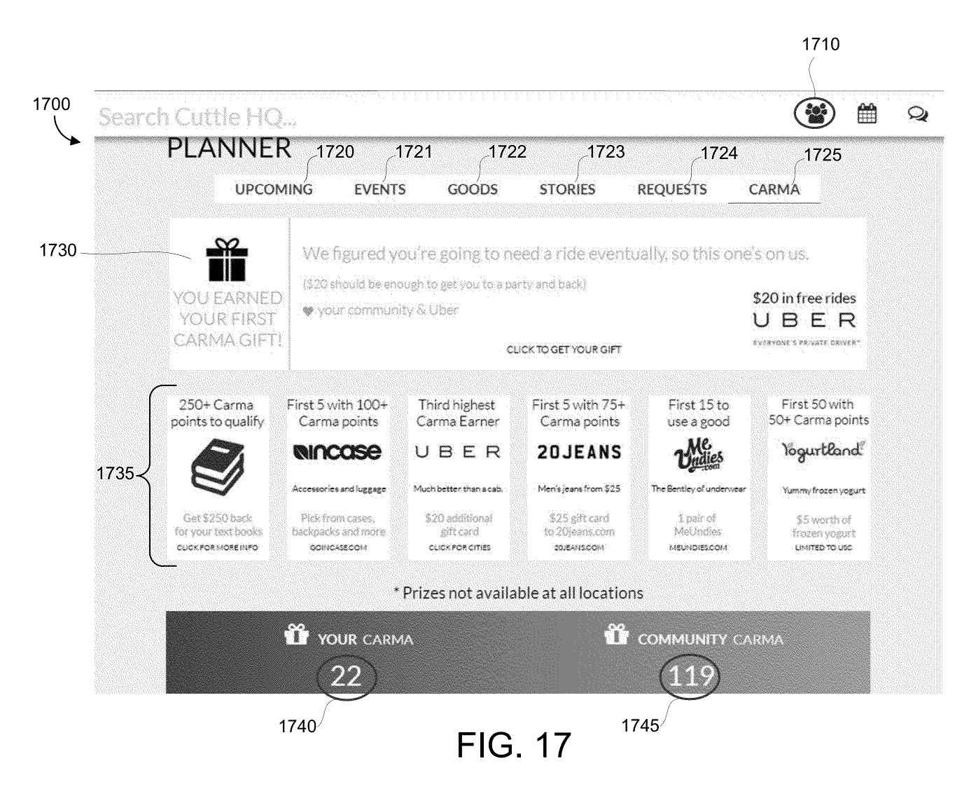

FIG. 17 illustrates a screen display 1700 that may be generated by one more of the systems discussed herein. Display 1700 is generated when the user selects the planner button 1710. Shown in the planner view are links for upcoming 1720, events 1721, good 1722, stories 1723, requests 1724 and carma 1725. Shown in this embodiment is the carma page. The carma page shows that this user has earned their first carma gift in display 1730. The user can select the click to get your gift link to receive the gift at their address. This page also informs the user to reach for other gifts by earning more pints in links 1735. Display 1700 also shows the number of points the user has accumulated 1740 (e.g. 22) and the number of points the user's community has earned 1745 (e.g. 119). In some embodiments, the user may become eligible for a gift by earning a certain number of minimum point and the user's community having a certain number of minimum points. For certain incentives both criteria regarding the points have to be met.

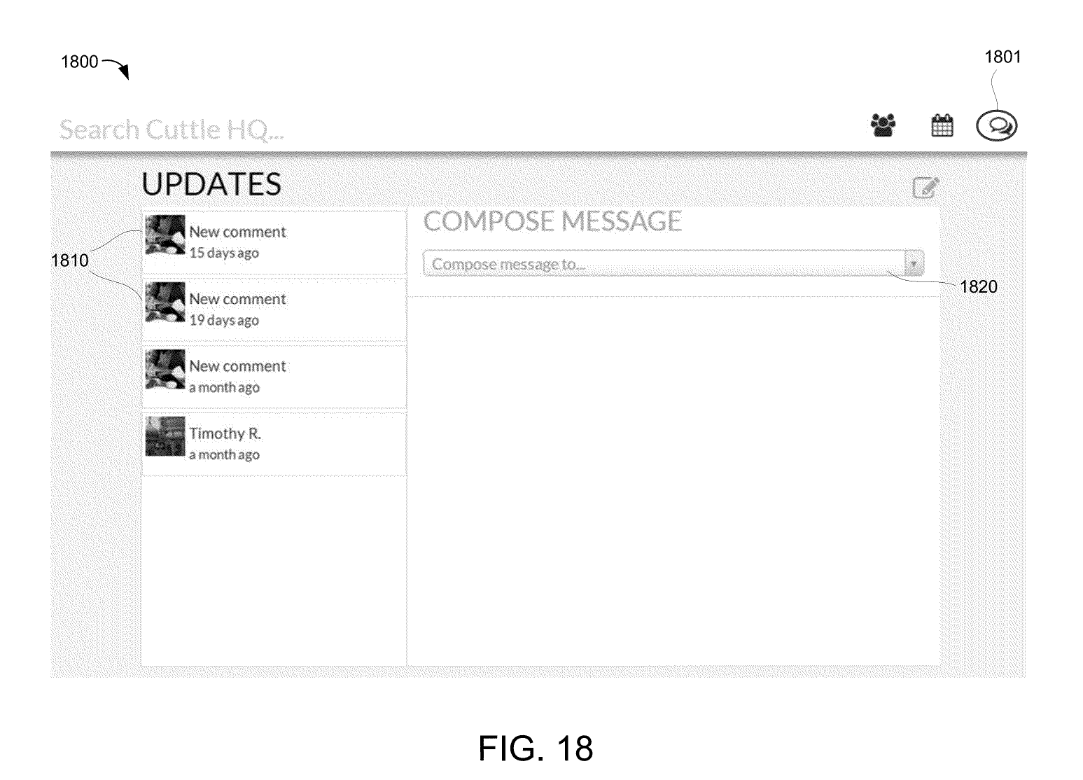

FIG. 18 illustrates a screen display 1800 that may be generated by one more of the systems discussed herein. FIG. 18 illustrates the display 1800 that may be shown to the user when the user selects comments button 1801. Shown in FIG. 18 are the new comments that have been posted and a pull down menu 1820 where the user ma post new comments related an event, story or good.

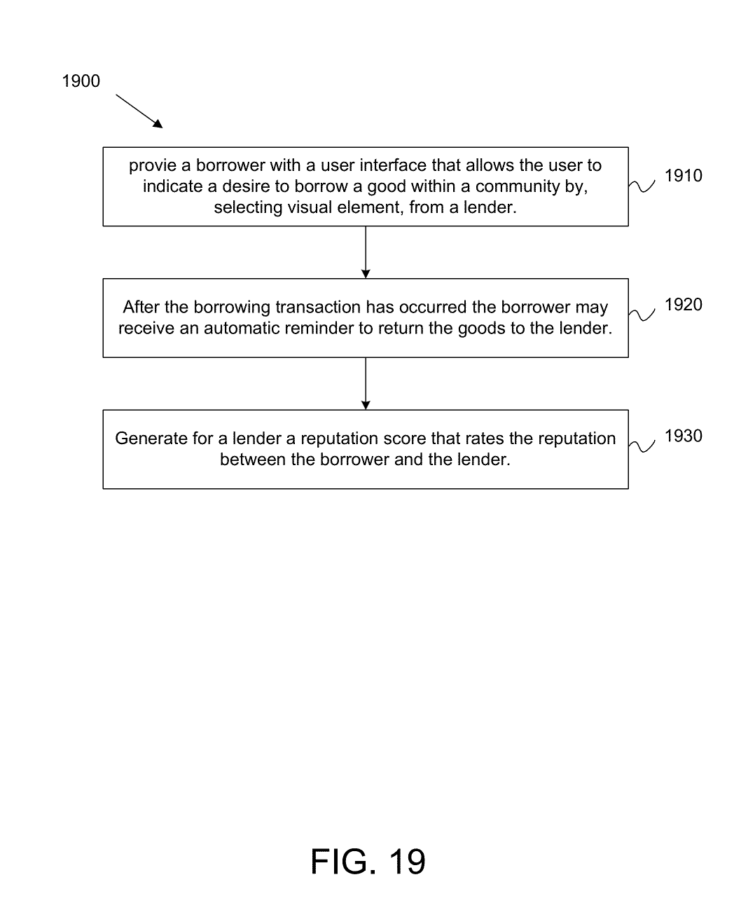

FIG. 19 illustrates a flow chart 1900 that may be implemented by one more of the systems discussed herein. At step 1910, the method includes providing a borrower with a user interface that allows the user to indicate a desire to borrow a good within a community by, selecting visual element, from a lender. In response to receiving such request, the system may ping a lender by generating for a lender a reputation score that rates the reputation between the borrower and the lender at step 1930. Next, at step 1920, after the borrowing transaction has occurred the borrower may receive an automatic reminder to return the goods to the lender.

The embodiments discussed herein have been described with reference to drawings. The drawings illustrate certain details of specific embodiments that implement the systems and methods and programs of the present invention. However, describing the invention with drawings should not be construed as imposing on the invention any limitations that may be present in the drawings. The embodiments contemplate methods, systems and program products on any machine-readable media for accomplishing its operations. The embodiments of the methods and systems may be implemented using an existing computer processor, or by a special purpose computer processor incorporated for this or another purpose or by a hardwired or wireless system.

As noted above, embodiments within the scope of the present invention include program products comprising non-transitory machine-readable media for carrying or having machine-executable instructions or data structures stored thereon. Such machine-readable media may be any available media that may be accessed by a general purpose or special purpose computer or other machine with a processor. By way of example, such machine-readable media may comprise RAM, ROM, EPROM, EEPROM, CD-ROM or other optical disk storage, magnetic disk storage or other magnetic storage devices, or any other medium which may be used to carry or store desired program code in the form of machine-executable instructions or data structures and which may be accessed by a general purpose or special purpose computer or other machine with a processor. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments described in the general context of method steps which may be implemented in one embodiment by a program product including machine-executable instructions, such as program code, for example in the form of program modules or electrical components executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

As previously indicated, embodiments of the present invention may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing computers in the form of computers, including a processing unit, a system memory or database, and a system bus that couples various system components including the system memory to the processing unit. A user computing device may be desktop computer, laptop computer, mobile computing device (e.g., handheld e-mail device, cellular phone, etc. The database or system memory may include read only memory (ROM) and random access memory (RAM). The database may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer. It should also be noted that the word “terminal” as used herein is intended to encompass computer input and output devices. User interfaces, as described herein may include a computer with monitor, keyboard, a keypad, a mouse, joystick or other input devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. Other substitutions, modifications, changes and omissions may be made in the design, operating conditions and arrangement of the embodiments without departing from the scope of the present invention.

Throughout the specification, numerous advantages of the exemplary embodiments have been identified. It will be understood of course that it is possible to employ the teachings herein without necessarily achieving the same advantages. Additionally, although many features have been described in the context of a particular data processing unit, it will be appreciated that such features could also be implemented in the context of other hardware configurations.

While the exemplary embodiments illustrated in the figures and described above are presently preferred, it should be understood that these embodiments are offered by way of example only. Other embodiments may include, for example, structures with different data mapping or different data. The invention is not limited to a particular embodiment, but extends to various modifications, combinations, and permutations that nevertheless fall within the scope and spirit of the appended claims.

What is claimed is:

1. A method comprising:
providing a borrower with a user interface that allows the user to indicate a desire to borrow a good within a community by, selecting visual element, from a lender;
automatically reminding a borrower to return the borrowed goods; and
generating for a lender a reputation score that rates the reputation between the borrower and the lender.

2. The method of claim 1, wherein the reputation score is determined based on past transactions of the borrower with other lenders.

3. The method of claim 2, wherein the rating of the borrower that is provided by the other lenders is used to determine the reputation score.

4. The method of claim 1, wherein the reputation score is a numerical value.

5. The method of claim 1, wherein the reputation score takes into account the lenders past transactions with other borrowers.

6. The method of claim 5, wherein the reputation score is determined based on receiving a selection of the lender and the borrower in real-time or is updated based on the most recent transaction of the borrower and the lender.

7. An apparatus, comprising:
a processor communicatively coupled to a non-transitory computer readable storage medium configured to:
provide a borrower with a user interface that allows the user to indicate a desire to borrow a good within a community with limited text input from a lender; wherein limited text input comprises selecting only visual elements that can be clicked on or selected by a users finger input;
automatically remind a borrower to return the borrowed goods based on a due date; and
generate for a lender a reputation score that rates the reputation between the borrower and the lender.

8. The apparatus of claim 7, wherein the reputation score is determined based on past transactions of the borrower with other lenders and the lender.

9. The method of claim 8, wherein the rating of the borrower that is provided by the other lenders is used to determine the reputation score; and
wherein the reminder is generated at least a few hours before the due date.

10. The apparatus of claim 7, wherein the reputation score is a numerical value wherein a users finger input fails to include a on screen keyboard.

11. The apparatus of claim 7, wherein the reputation score takes into account the lenders past transactions with other borrowers.

12. The apparatus of claim 11, wherein the reputation score is determined based on receiving a selection of the lender and the borrower in real-time or is updated based on the most recent transaction of the borrower and the lender.

13. A computer readable medium containing program instructions, wherein execution of the program instructions by one or more processors of a computer system causes the one or more processors to carry out the steps of:
provide a borrower with a user interface that allows the user to indicate a desire to borrow a good within a community from a lender;
automatically remind a borrower by sending a message to the borrower to return the borrowed goods; and
generate for a lender a reputation score that rates the reputation between the borrower and the lender.

14. The method of claim 13, wherein the reputation score is determined based on past transactions of the borrower with other lenders.

15. The method of claim 14, wherein the rating of the borrower that is provided by the other lenders is used to determine the reputation score.

16. The method of claim 12, wherein the reputation score is a numerical value.

17. The method of claim 12, wherein the reputation score takes into account the lenders past transactions with other borrowers.

18. The method of claim 17, wherein the reputation score is determined based on receiving a selection of the lender and the borrower in real-time or is updated based on the most recent transaction of the borrower and the lender.
